(19) United States
(12) Patent Application Publication
(10) Pub. No.: US 2024/0006943 A1
(43) Pub. Date: Jan. 4, 2024

(54) ELECTRIC MOTOR WITH CENTRIFUGAL PUMP TO FLOW FLUID IN ROTOR CHANNEL

(71) Applicant: Atieva, Inc., Newark, CA (US)

(72) Inventors: Mahsaalsadat Mortazavi Ravari, Redwood City, CA (US); Noe Banuelos, Hayward, CA (US); Barnaby James Gerard Lewis, San Francisco, CA (US); Ahmad Abdullah Alawaji, Fremont, CA (US)

(21) Appl. No.: 18/342,306

(22) Filed: Jun. 27, 2023

Related U.S. Application Data
(60) Provisional application No. 63/367,564, filed on Jul. 1, 2022.

(51) Int. Cl. H02K 1/32; H02K 5/15; H02K 1/27

(52) U.S. Cl. CPC H02K 1/32; H02K 5/15; H02K 1/27

(57) ABSTRACT

An electric motor comprises: a stator; and a rotor comprising: a rotor body; and a centrifugal pump to flow a fluid in a channel extending axially through the rotor body from end to end. The channel can extend through a magnet hole in the rotor body. The channel can be formed in a hole of the rotor body that does not contain a magnet. The electric motor can include first and second end plates forming the centrifugal pump. The first and second end plates can be clocked with each other. The first and second end plates can be non-clocked with each other.

### CROSS-REFERENCE TO RELATED APPLICATION

This application claims priority to, and benefit under 35 U.S.C. § 119, of U.S. Provisional Patent Application No. 63/367,564, filed on Jul. 1, 2022, entitled “ELECTRIC MOTOR WITH CENTRIFUGAL PUMP TO FLOW FLUID IN ROTOR CHANNEL,” the disclosure of which is incorporated by reference herein in its entirety.

### TECHNICAL FIELD

This document relates to an electric motor with a centrifugal pump to flow fluid in a rotor channel.

### BACKGROUND

In recent years, the world's transportation has begun a transition away from powertrains primarily driven by fossil fuels and toward more sustainable energy sources. The majority of such increasingly prevalent powertrains include electric motors powered by on-board energy storages. Electric motors generate heat during operation, and their efficiency and other performance characteristics in part depend on the thermal control strategy.

### SUMMARY

In an aspect, an electric motor comprises: a stator; and a rotor comprising: a rotor body; and a centrifugal pump to flow a fluid in a channel extending axially through the rotor body from end to end.

Implementations can include any or all of the following features. The channel extends through a magnet hole in the rotor body. The channel is formed adjacent a magnet positioned in the magnet hole. The channel is formed between at least two magnets positioned in the magnet hole. The channel is formed in a hole of the rotor body that does not contain a magnet. The rotor body is formed by laminates, and wherein the laminates contain respective holes that form the channel. The electric motor includes first and second end plates forming the centrifugal pump, and wherein the first and second end plates are clocked with each other. The electric motor includes first and second end plates forming the centrifugal pump, and wherein the first and second end plates are non-clocked with each other. The electric motor includes first and second end plates forming the centrifugal pump, wherein the channel comprises first and second channels formed by the laminates, and wherein a first flow through the first channel occurs in an opposite direction to a second flow through the second channel. The electric motor includes first and second end plates forming the centrifugal pump, wherein the channel comprises first and second channels formed by the laminates, and wherein a first flow through the first channel occurs in a same direction as a second flow through the second channel. The channel comprises first and second channels formed by the laminates. The electric motor includes an end plate forming the centrifugal pump, wherein the centrifugal pump comprises an inlet formed in the end plate, the inlet aligned with the first channel, and an outlet formed in the end plate, the outlet aligned with the second channel, wherein the centrifugal pump flows first fluid into the first channel and flows second fluid out of the second channel. The inlet comprises a hole through the end plate, a recessed area in the end plate that does not abut the laminates, the recessed area covering the first channel, and an outside peripheral lip that closes the recessed area. The electric motor further comprises a rib that divides the recessed area to guide the fluid at the inlet. The recessed area has substantially an arcuate shape. The recessed area has substantially a wedge shape. The inlet further comprises a scoop forming the hole. The outlet comprises a recessed area in the end plate that does not abut the laminates, the recessed area covering the second channel, and a recess in an outside peripheral lip of the end plate. The recessed area is symmetric about a radius of the rotor body. The end plate comprises multiple pairs each including a respective inlet and a respective outlet, the multiple pairs distributed about a periphery of the end plate. The end plate further comprises a site with material removed for rotor balancing. An inlet for the channel is formed in a shaft of the rotor. The fluid comprises at least one of air or oil.

### BRIEF DESCRIPTION OF DRAWINGS

FIGS. 1A-1B show examples of an end plate that can be used to provide a centrifugal pump for a rotor.

FIG. 2 shows an example of a rotor lamination that can be used with a centrifugal pump to provide cooling.

FIG. 3 schematically shows a cross section of an electric motor.

FIG. 4 shows examples of diagrams regarding testing of the end plates of FIGS. 1A-1B.

FIG. 5 shows another example of a rotor lamination that can be used with a centrifugal pump to provide cooling.

FIGS. 6-9 show other examples of end plates that can be used to provide a centrifugal pump for a rotor.

FIG. 10 schematically shows a section of balancing plates and air channels in a rotor stack to illustrate a flow of fluid by way of a centrifugal pump.

FIGS. 11A-11D show examples of various locations within a rotor stack being used as channels for fluid flow.

FIGS. 12A-12C show radial views relating to the rotor laminations in FIGS. 11A-11D.

FIGS. 13A-13B show examples relating to an end plate with outlet channels, and an end plate with inlet channels, respectively.

Like reference symbols in the various drawings indicate like elements.

### DETAILED DESCRIPTION

This document describes examples of systems and techniques for thermally controlling an electric motor using at least one centrifugal pump with a channel extending axially through the rotor. This can provide a significant lowering of the rotor temperature also under challenging operational cycles, for example similar to the test results discussed below. An end plate for a rotor lamination stack can at least in part provide the rotor with a centrifugal pump. For example, the end plate can also be used for one or more other purposes, including, but not limited to, in adjusting a distribution of material when balancing the rotor.

Examples described herein refer to an electric motor. As used herein, an electric motor can be any type of electric motor, including, but not limited to, a permanent-magnet motor, an induction motor, a synchronous motor, or a reluctance motor.

Examples described herein refer to a top, bottom, front, or rear. These and similar expressions identify things or aspects in a relative way based on an express or arbitrary notion of perspective. That is, these terms are illustrative only, used for purposes of explanation, and do not necessarily indicate the only possible position, direction, and so on.

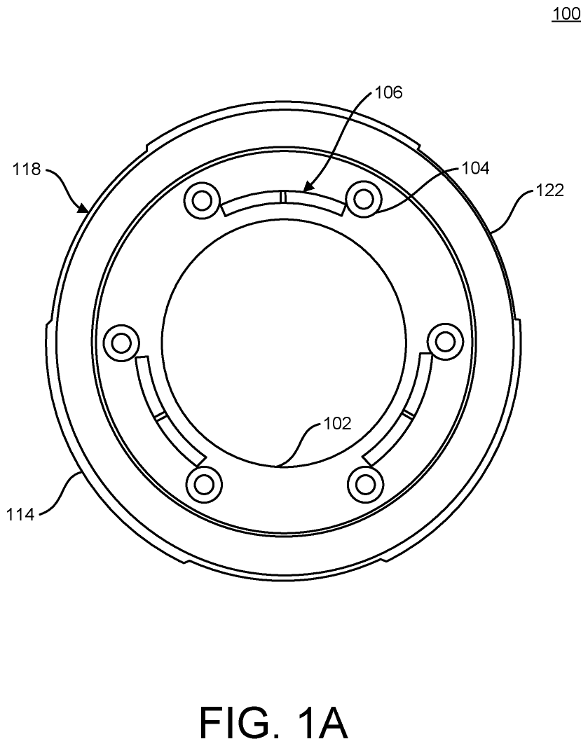

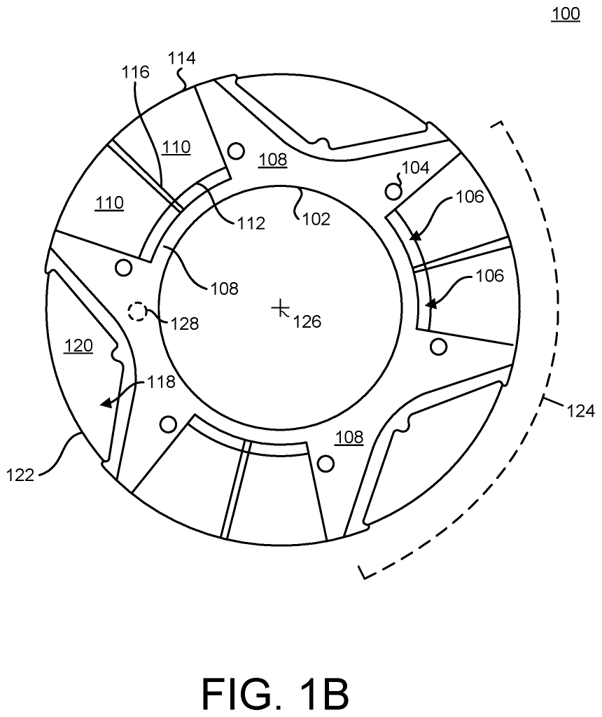

FIGS. 1A-1B show examples of an end plate 100 that can be used to provide a centrifugal pump for a rotor. The end plate 100 can be used with one or more other examples described elsewhere herein. In FIG. 1A, the end plate 100 is shown in a plan view to illustrate the surface of the end plate 100 that faces outward from the rotor laminations (not shown) when installed. In FIG. 1B, the end plate 100 is shown in a plan view to illustrate the surface of the end plate 100 that faces inward toward the rotor laminations (not shown) when installed. The end plate 100 has a central opening 102 (e.g., of circular shape) that can accommodate a rotor shaft (not shown) and/or another component. The end plate 100 includes holes 104 for installation of rivets that may extend through the rotor stack from end to end for compressing the rotor. For example, the holes 104 can be chamfered at the outside face of the end plate 100.

The end plate 100 can form one or more inlets 106 for a centrifugal pump. The inlet(s) 106 allow the centrifugal pump to draw fluid and flow the fluid through at least one channel in the rotor body. The end plate 100 can have a surface 108 for abutting the end of the rotor body (e.g., the outermost of multiple rotor laminations). The inlet 106, moreover, can be formed by one or more features defined in relation to the surface 108. In some implementations, the inlet 106 includes a recessed area 110. The recessed area 110 can be a portion where the end plate 100 has a smaller thickness than at the surface 108. As such, the recessed area 110 of the end plate 100 does not abut the end of the rotor body when installed. The inlet 106 includes a hole 112 extending through a thickness of the end plate 100. The hole 112 can have any shape, including, but not limited to, a deformed rectangle (e.g., as shown). Other shapes can be used for the hole 112. The recessed area 110 can have any shape. In some implementations, the recessed area 110 can be substantially symmetric about a radius of the end plate 100 (e.g., as shown). For example, the recessed area 110 can be symmetric about the hole 112. In some implementations, the recessed area 110 can have substantially a wedge shape (e.g., as shown).

The inlet 106 includes an outside peripheral lip 114 that closes the recessed area 110. The outside peripheral lip 114 can extend substantially around the entire periphery of the end plate 100, except as noted in examples described below. At the outside peripheral lip 114, the end plate 100 may have substantially the same thickness as at the surface 108. For example, when the end plate 100 is installed, the outside peripheral lip 114 can abut the end of the rotor body.

The inlet 106 can include one or more ribs. In some implementations, the recessed area 110 is divided by at least one rib 116. For example, the rib 116 can divide the recessed area 110 to guide the fluid at the inlet 106.

The end plate 100 can form one or more outlets 118 for the centrifugal pump. The outlet(s) 118 allow the centrifugal pump to expel fluid that has flowed through at least one channel in the rotor body. That is, the outlet(s) 118 of the end plate 100 can expel fluid that originally entered the rotor through another inlet at the opposite end of the rotor, not through any of the inlets 106 of the end plate 100. The outlet(s) 118 can be formed by one or more features defined in relation to the surface 108. In some implementations, the outlet(s) 118 includes a recessed area 120. The recessed area 120 can be a portion where the end plate 100 has a smaller thickness than at the surface 108. As such, the recessed area 120 of the end plate 100 does not abut the end of the rotor body when installed. The recessed area 120 can have any shape. In some implementations, the recessed area 120 can be substantially symmetric about a radius of the end plate 100 (e.g., as shown).

The outlet(s) 118 includes a recess 122 in the outside peripheral lip 114. At the recess 122, the end plate 100 may have a smaller thickness than at the surface 108. For example, at the recess 122 the end plate 100 may have substantially the same thickness as does the recessed area 120. The recess 122 allows fluid in the recessed area 120 to be expelled away from the end plate 100.

The inlet 106 and the outlet 118 positioned adjacent each other can form a pair 124. The end plate 100 can include multiple instances of the pair 124 distributed about a periphery of the end plate 100. For example, here the end plate 100 includes three instances of the pair 124 that are equally distributed.

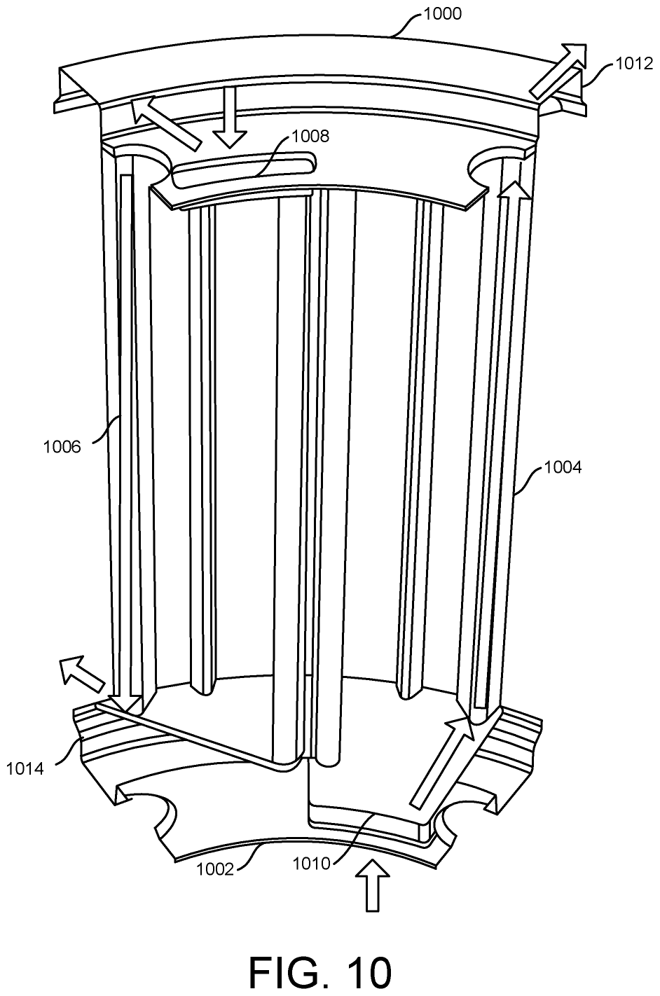

When being installed on the rotor, the end plate 100 can be clocked with a corresponding (e.g., identical) end plate mounted to the opposite rotor end. That is, of the possible angular orientations in which the end plate 100 can be installed (i.e., so that the holes 104 line up for rivet installation), the orientation is chosen so that each of the inlets 106 of the end plate 100 lines up with a corresponding outlet of the other end plate at the opposite end. This clocking will allow the centrifugal pump to draw fluid through one of the inlets 106, flow the fluid through a channel, and expel the fluid through the outlet at the opposite end plate. Likewise, the clocking will allow the centrifugal pump to draw fluid through one of the inlets at the opposite end plate, flow the fluid through another channel, and expel the fluid through one of the outlets 118. An example involving centrifugal pumps flowing fluid in opposite directions along a rotor stack is described below with reference to FIG. 10.

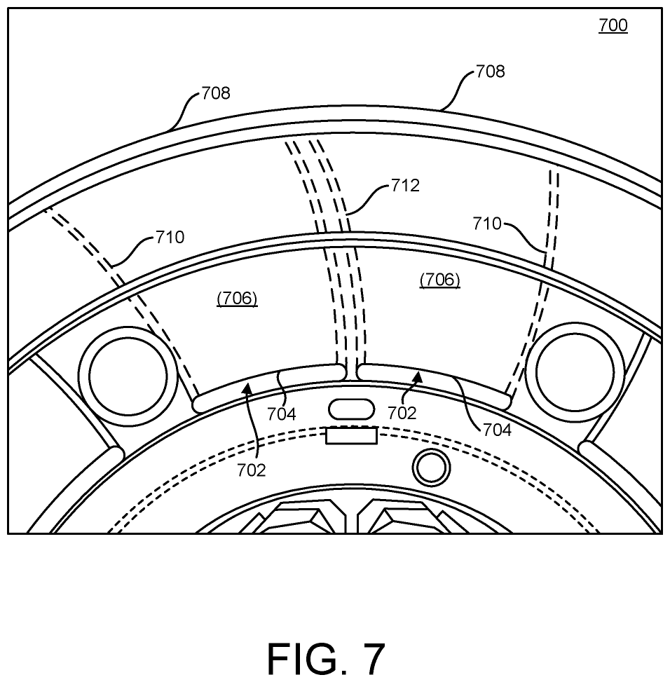

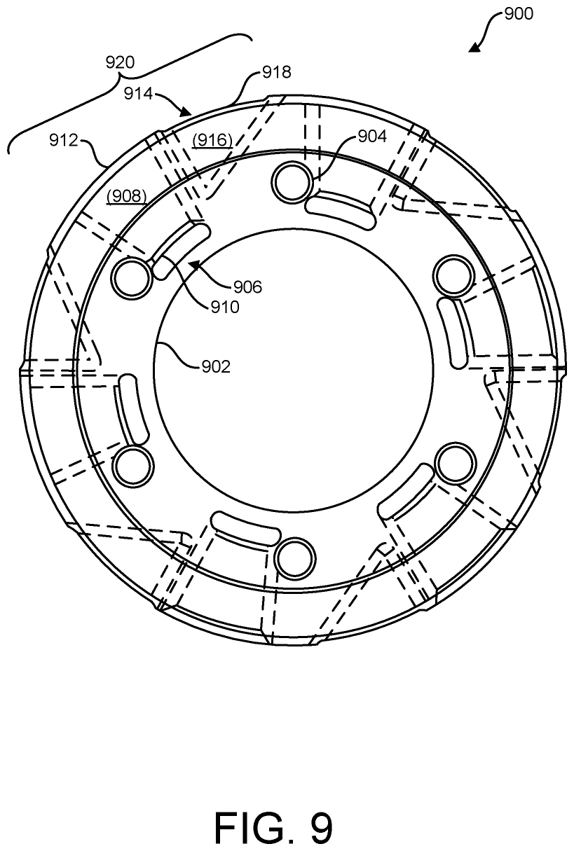

That is, with some example designs described herein (e.g., in FIGS. 1A-1B, 6, 7, or 8) clocking will be performed during installation to ensure that inlets and outlets at opposite ends of a rotor stack are properly lined up with each other. With other designs, such as the one shown in FIG. 9, clocking is not necessary. Rather, this design ensures that inlets and outlets are automatically aligned with each other at the ends of the rotor.

In some implementations, the end plate 100 can serve to provide the rotor with a centrifugal pump, and can also serve one or more additional purposes. For example, the end plate 100 can also be considered a balancing plate for the rotor. Rotor balancing can be performed to ensure that the rotor center of gravity is aligned with an axis of rotation 126 of the rotor. Here, the axis of rotation 126 is positioned in the center of the central opening 102. If an imbalance is discovered, material can be removed from one or more locations on the end plate 100 to adjust a distribution of material. In some implementations, material is preferably removed somewhere within the portion where the end plate 100 has its greatest thickness. This can include, but is not limited to, at least one location within the surface 108. A site 128 within the surface 108 is here shown for illustrative purposes only. One or more other locations can be used instead or additionally. The site 128 can have any shape. For example, if material is removed by drilling, the site 128 may have substantially a circular shape.

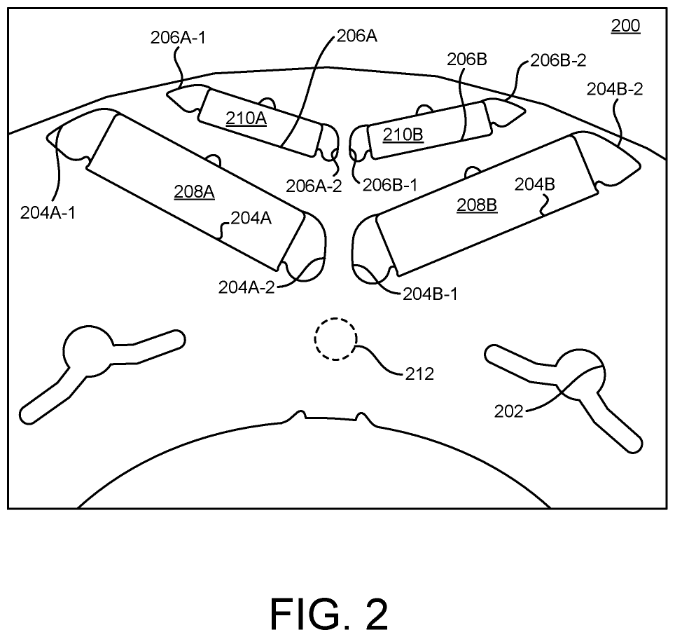

FIG. 2 shows an example of a rotor lamination 200 that can be used with a centrifugal pump to provide cooling. The rotor lamination 200 can be used with one or more other examples described elsewhere herein. The rotor lamination 200 can be rotationally symmetric and only a portion of the rotor lamination 200 is here shown for simplicity.

A stack of multiple instances of the rotor lamination 200 can be assembled to form the body of the rotor. The rotor lamination 200 can include at least one rivet hole 202 that can accommodate a rivet extending axially through the rotor body for axial compression.

The rotor lamination 200 can include one or more holes for accommodating permanent magnets. Here, the rotor lamination 200 includes holes 204A-204B and 206A-206B. One or more magnets can be placed in one or more of the holes 204A-204B and 206A-206B. Here, the hole 204A includes a magnet 208A, the hole 204B includes a magnet 208B, the hole 206A includes a magnet 210A, and the hole 206B includes a magnet 210B, respectively. Any type(s) of permanent magnets can be used, including, but not limited to, sintered and/or bonded permanent magnets. Here, the holes 204A-204B and 206A-206B are internal to the rotor. In some implementations, one or more of the holes 204A-204B and 206A-206B can instead accommodate a surface-mounted magnet.

The holes 204A-204B and 206A-206B can have any of multiple positions within the rotor lamination 200. Here, the holes 204A-204B are symmetrical about a radius of the rotor lamination 200. Similarly, the holes 206A-206B are symmetrical about a radius of the rotor lamination 200.

Potting can be used for one or more of the magnets 208A-208B and/or 210A-210B. For example, a liquid potting material can be injected so as to flow onto at least one side of one or more of the magnets 208A-208B and/or 210A-210B.

In some implementations, potting is not used. Here, holes 204A-1 and 204A-2 are portions of the hole 204A not occupied by the magnet 208A, and are substantially free from potting. Similarly, holes 204B-1 and 204B-2 are portions of the hole 204B not occupied by the magnet 208B, and are substantially free from potting; holes 206A-1 and 206A-2 are portions of the hole 206A not occupied by the magnet 210A, and are substantially free from potting; and holes 206B-1 and 206B-2 are portions of the hole 206B not occupied by the magnet 210B, and are substantially free from potting. The holes 204A-1 and 204A-2, holes 204B-1 and 204B-2, holes 206A-1 and 206A-2, and holes 206B-1 and 206B-2 can serve as barriers for magnetic flux during operation.

The holes 204A-1, 204A-2, 204B-1, 204B-2, 206A-1, 206A-2, 206B-1, or 206B-2 can have any position within the rotor lamination 200. Here, the holes 204A-1 and 204B-2 are symmetrical about a radius of the rotor lamination 200. Similarly, the holes 204A-2 and 204B-1 are symmetrical about the radius; the holes 206A-1 and 206B-2 are symmetrical about the radius; and the holes 206A-2 and 206B-1 are symmetrical about the radius.

One or more of the holes 204A-1, 204A-2, 204B-1, 204B-2, 206A-1, 206A-2, 206B-1, or 206B-2 can serve as a channel through the rotor for thermal control. For example, a fluid can be flowed through the channel(s). Any of multiple fluids can be used, including, but not limited to, a gas (e.g., air) or oil. As such, the channel(s) of a centrifugal pump can extend through one or more of the holes 204A-1, 204A-2, 204B-1, 204B-2, 206A-1, 206A-2, 206B-1, or 206B-2. Here, the holes 204A-1 and 204A-2 are formed adjacent the magnet 208A. Similarly, the holes 204B-1 and 204B-2 are formed adjacent the magnet 208B; the holes 206A-1 and 206A-2 are formed adjacent the magnet 210A; and the holes 206B-1 and 206B-2 are formed adjacent the magnet 210B.

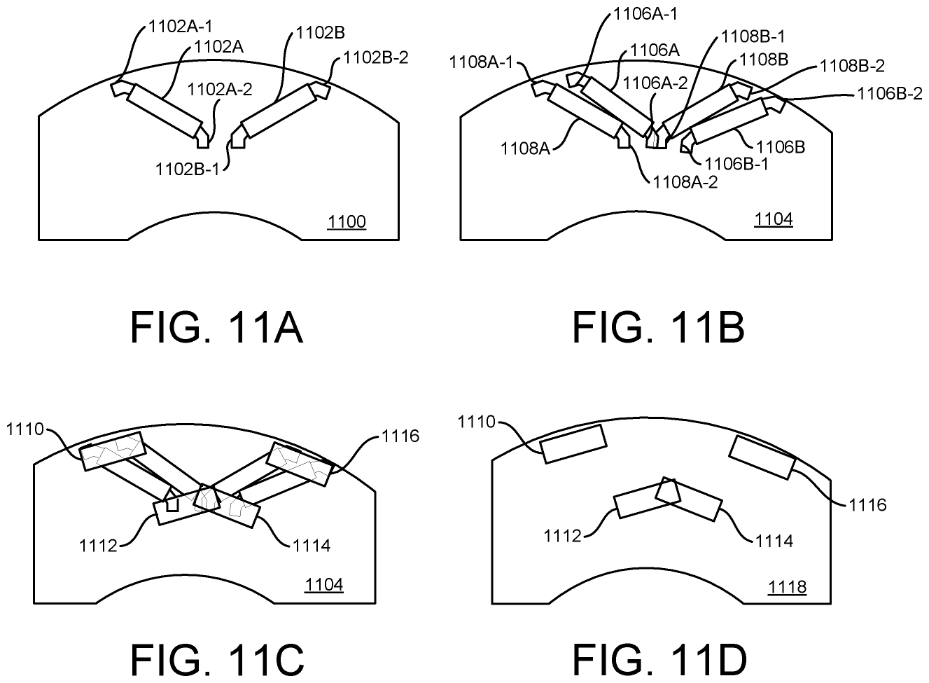

A channel for fluid flow can also or instead be formed in a hole of the rotor body that does not contain a magnet. In some implementations, the rotor lamination 200 can include a hole 212 that can form at least one channel. The hole 212 can have any shape, including, but not limited to, a circular shape. Additional examples are described below with reference to FIGS. 11A-11D.

Each of the holes 204A-1, 204A-2, 204B-1, 204B-2, 206A-1, 206A-2, 206B-1, or 206B-2 can align with an inlet or an outlet in an end plate of the rotor (e.g., the inlet 106 and the outlet 118 of FIGS. 1A-1B). In some implementations, each of the holes 204A-1, 204A-2, 204B-1, 204B-2, 206A-1, 206A-2, 206B-1, or 206B-2 aligns with an inlet at one end plate and with an outlet at the opposite end plate of the rotor.

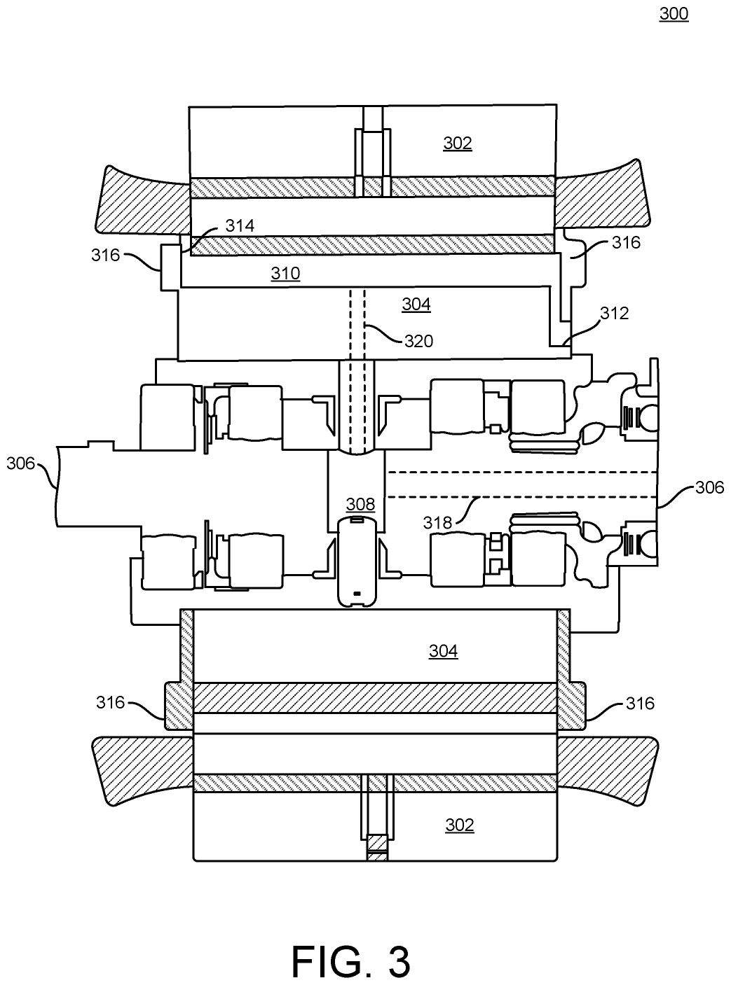

FIG. 3 schematically shows a cross section of an electric motor 300. The electric motor 300 can be used with one or more other examples described elsewhere herein. Only portions of the electric motor 300 are shown for clarity. The electric motor 300 includes a stator 302 and a rotor 304. The rotor 304 is mounted to a rotor shaft 306. A differential 308 can be positioned inside the rotor 304 (e.g., in a center of the rotor shaft 306). Namely, the rotor shaft 306 can be a hollow rotor shaft that accommodates a differential gear assembly for the vehicle. Such a differential gear assembly can provide the electric motor 300 with an active core. For example, the active core can include gears, gear bearings, and radial pins assembled as a differential. One or more hollow extensions (e.g., hollow cross-members) can be positioned in the hollow rotor shaft as part of the differential gear assembly. For example, the hollow extensions has one or more thru-holes in which a pin can be positioned (e.g., by a friction fit).

The rotor 304 can have a body formed by laminations (e.g., the rotor lamination 200 in FIG. 2). The rotor 304 can have one or more centrifugal pumps. A channel 310 can be formed in the rotor 304. For example, the channel 310 can be formed by one or more of the holes 204A-1, 204A-2, 204B-1, 204B-2, 206A-1, 206A-2, 206B-1, 206B-2, or 212 in FIG. 2. The rotor 304 can have an inlet 312 leading to the channel 310. For example, the inlet 312 can be formed by the inlet 106 of FIGS. 1A-1B. The rotor 304 can have an outlet 314 from the channel 310. For example, the outlet 314 can be formed by the outlet 118 of FIGS. 1A-1B. The inlet 312 and outlet 314 can be formed in respective instances of an end plate 316 for the rotor 304. For example, the instances of the end plate 316 can be identical to each other. In some implementations, the end plates 316 can be clocked, or non-clocked, with regard to each other.

In operation, fluid (e.g., air, oil or another substance) can enter the rotor 304 at the inlet 312. This fluid can be considered to have a relatively cool temperature. The fluid absorbs thermal energy from the rotor 304 in passing through the channel 310. As such, when reaching the outlet 314 the fluid can be considered to have a relatively hot temperature. In some implementations, the electric motor 300 has multiple channels corresponding to the channel 310, and all of the channels conduct fluid in the direction illustrated by the present example (e.g., from right to left in the drawing). In other implementations, one or more channels can instead conduct fluid in the opposite direction (e.g., from left to right in the drawing). For example, the rotor 304 can have as many right to left channels as it has left-to-right channels.

The channel 310 can instead be provided with fluid flow through the rotor shaft 306. In some implementations, a channel 318 can be formed in the rotor shaft 306, and a channel 320 can be formed through the rotor laminations. The channel 320 can be oriented radially and in positioned in the middle of the rotor 304 (e.g., as shown), or can be axially offset toward either end of the rotor body. The channels 318 and 320 can form an inlet for the channel 310 and thereby provide a flow of fluid into the channel 310. The fluid entering the channel 310 can then flow in either or both directions within the channel 310. For example, the channel 310 can direct the flow from the channel 320 towards the opposing ends of the rotor body.

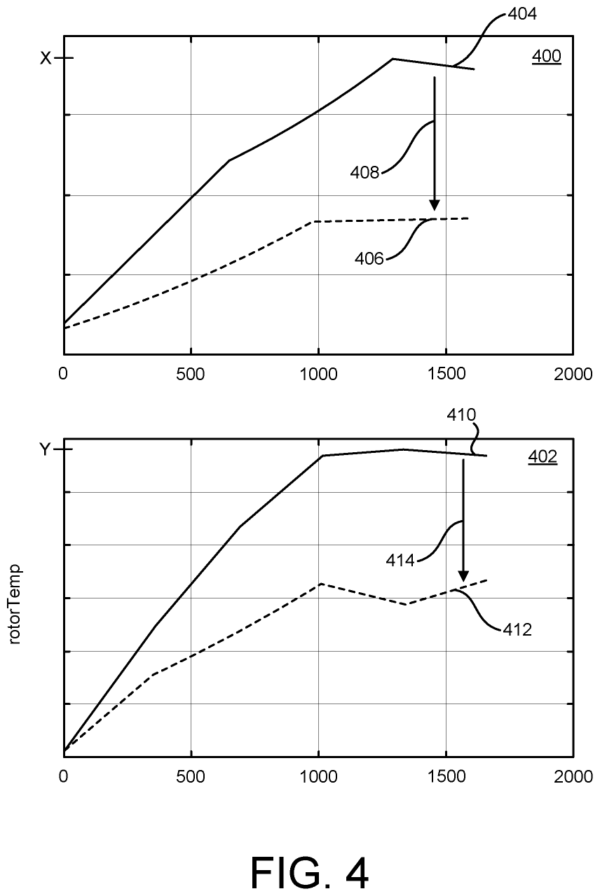

FIG. 4 shows examples of diagrams 400 and 402 regarding testing of the end plates of FIGS. 1A-1B. The diagrams 400 and 402 can illustrate characteristics of one or more other examples described elsewhere herein. Each of the diagrams 400 and 402 shows rotor temperature (e.g., magnet temperature) indicated against a vertical axis as a function of time indicated against a horizontal axis. The diagrams 400 and 402 correspond to different test cycles for the rotor (e.g., different operational loads).

The diagram 400 includes a graph 404 and a graph 406. The graph 404 reflects the rotor temperature when a centrifugal pump is not used. For example, the graph 404 shows that the temperature approaches a value of X degrees Celsius during a portion of the test cycle. The graph 406, on the other hand, shows that the rotor temperature remains well below the temperature X. As such, an arrow 408 schematically illustrates that the centrifugal pump can significantly lower the temperature during a test cycle.

The diagram 402 includes a graph 410 and a graph 412. The graph 410 reflects the rotor temperature when the centrifugal pump is not used. For example, the graph 410 shows that the temperature approaches a value of Y degrees Celsius during a portion of the test cycle. The graph 412, on the other hand, shows that the rotor temperature remains well below the temperature Y. As such, an arrow 414 schematically illustrates that the centrifugal pump can significantly lower the temperature during a test cycle.

FIG. 5 shows another example of a rotor lamination 500 that can be used with a centrifugal pump to provide cooling. The rotor lamination 500 can be used with one or more other examples described elsewhere herein. The rotor lamination 500 can be similar to the rotor lamination 200 (FIG. 2) in some regards. In the following, only differences in the rotor lamination 500 compared to the rotor lamination 200 are discussed for brevity.

The rotor lamination 500 includes a hole 502. In some implementations, the hole 502 is formed between at least two magnets in the rotor lamination 500. For example, magnets 504A and 504B can be positioned in the hole 204A so that the hole 502 is formed between the magnets 504A and 504B. As such, a channel for a centrifugal pump can be formed between at least two magnets in the rotor lamination 500, such as the magnets 504A and 504B. The rotor lamination 500 can include one or more other holes for the same centrifugal pump or another centrifugal pump. Such hole(s) can be formed adjacent a magnet and/or between magnets, to name just two examples.

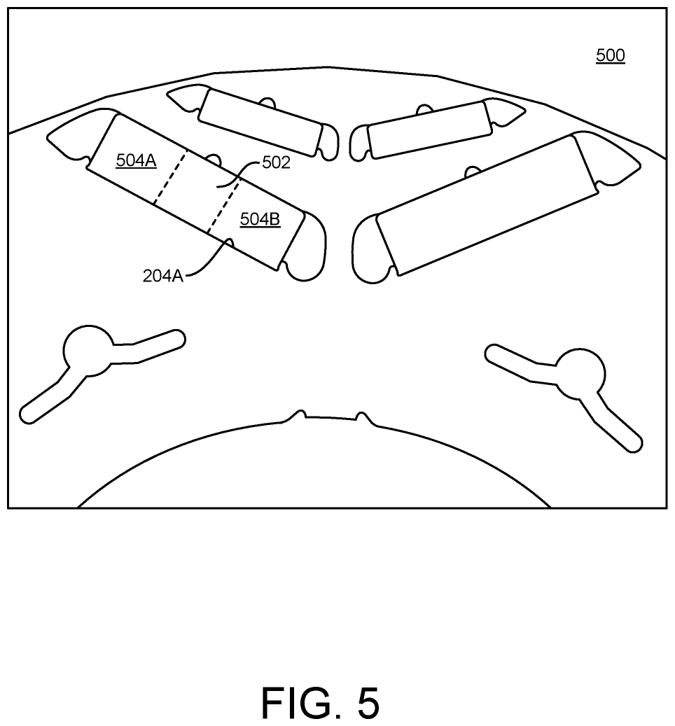

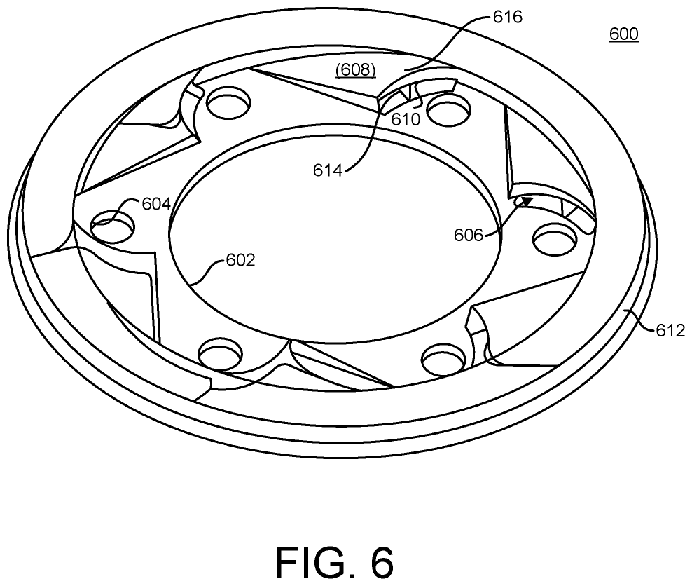

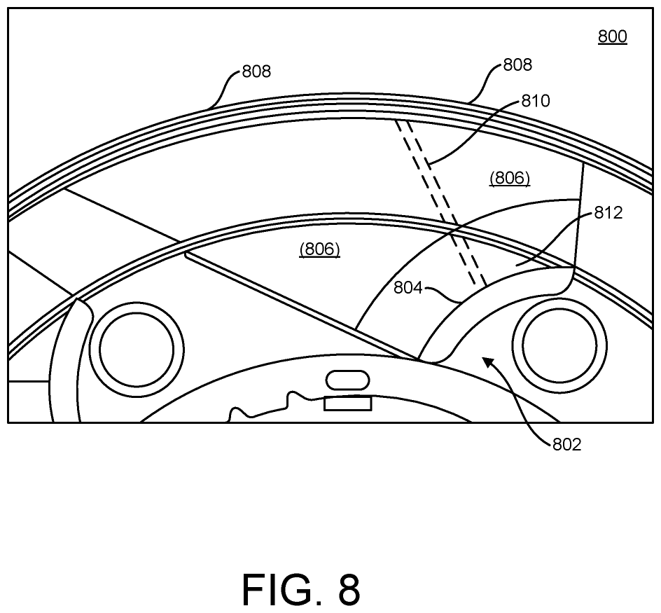

FIGS. 6-9 show other examples of end plates 600, 700, 800, and 900 that can be used to provide a centrifugal pump for a rotor. One or more of the end plates 600, 700, 800, or 900 can be used with one or more other examples described elsewhere herein.

The end plate 600 is shown in a perspective view to illustrate the surface of the end plate 600 that faces outward from the rotor laminations (not shown) when installed. An opposite surface of the end plate 600 (not shown) instead faces inward toward the rotor laminations when installed. The end plate 600 has a central opening 602 (e.g., of circular shape) that can accommodate a rotor shaft (not shown) and/or another component. The end plate 600 includes holes 604 for installation of rivets that may extend through the rotor stack from end to end for compressing the rotor. For example, the holes 604 can be chamfered at the outside face of the end plate 600.

The end plate 600 can form one or more inlets 606 for a centrifugal pump. The inlet(s) 606 allow the centrifugal pump to draw fluid and flow the fluid through at least one channel in the rotor body. The end plate 600 can have a surface for abutting the end of the rotor body (e.g., the outermost of multiple rotor laminations). The inlet 606, moreover, can be formed by one or more features defined in relation to such a surface. In some implementations, the inlet 606 includes a recessed area 608. The recessed area 608 is here hidden from view. The recessed area 608 can be a portion where the end plate 600 has a smaller thickness than at the lamination-abutting surface. As such, the recessed area 608 of the end plate 600 does not abut the end of the rotor body when installed. The inlet 606 includes a hole 610 extending through the end plate 600. The hole 610 can have any shape, including, but not limited to, a deformed rectangle (e.g., a non-planar rectangle as shown). Other shapes can be used for the hole 610. The recessed area 608 can have any shape. In some implementations, the recessed area 110 can be substantially symmetric about a radius of the end plate 600. In some implementations, the recessed area 608 can have substantially a wedge shape (e.g., as shown).

The inlet 606 includes an outside peripheral lip 612 that closes the recessed area 608. The outside peripheral lip 612 can extend substantially around the entire periphery of the end plate 600, except as noted in examples described below. At the outside peripheral lip 612, the end plate 600 may have substantially the same thickness as at the lamination-abutting surface. For example, when the end plate 100 is installed, the outside peripheral lip 612 can abut the end of the rotor body.

The inlet 606 can include one or more ribs. In some implementations, the recessed area 608 is divided by at least one rib 614. For example, the rib 614 can divide the recessed area 608 to guide the fluid at the inlet 606.

The end plate 600 does not have any outlet section for a centrifugal pump. Rather, the outlets for the channels that are fed by the inlets 606 are at the opposite end of the rotor and are there formed in another end plate. For example, in that other end plate, portions can be opened at the outer diameter of the rotor to allow the flow to exit the end plate. That is, the designs of the present subject matter can be any of the following (i) either all inlets are positioned at one end of the rotor, and all outlets at the other end, in which case all of the flow is from one end of the rotor toward the other (with the loop being closed by flow travelling through the airgap between the rotor and stator); or (ii) inlets and outlets can alternate within the same end plate, and reciprocally at the opposite end plate, with alternating flow direction along the length of the rotor.

The inlet 606 can include a scoop 616 at the hole 610. In operation, the scoop 616 can grab fluid (e.g., air or oil) and push it into the inlet 606.

The end plate 600 can be non-clocked with regard to an end plate at the opposite end of the rotor body. For example, every rotational position of the end plate 600 can align the inlet 606 with a corresponding outlet at the opposite end plate.

Turning now to the end plate 700, it can be similar to the end plate 600 or 100 in some regards. In the following, only differences in the end plate 700 compared to the end plate 600 or 100 are discussed for brevity. The end plate 700 has an inlet 702 that includes a hole 704, a recessed area 706, and an outside peripheral lip 708 that closes the recessed area 706. The recessed area 706 is here hidden from view. The recessed area 706 has an arcuate shape. In some implementations, walls 710 (hidden from view) that define the recessed area 706 can be curved. For example, the walls can be curved in a direction opposite the rotational direction of the end plate 700. A rib 712 (hidden from view) can divide the recessed area 706 and guide fluid at the inlet 702. For example, the rib 712 can have an arcuate shape.

Continuing with the end plate 800, it can be similar to the end plate 700, 600, or 100 in some regards. In the following, only differences in the end plate 800 compared to the end plate 700, 600, or 100 are discussed for brevity. The end plate 800 has an inlet 802 that includes a hole 804, a recessed area 806, and an outside peripheral lip 808 that closes the recessed area 806. The recessed area 806 is here hidden from view. The recessed area 806 has a wedge shape. A rib 810 (hidden from view) can divide the recessed area 806 and guide fluid at the inlet 802. The inlet 802 can include a scoop 812 at the hole 804. In operation, the scoop 812 can grab fluid (e.g., air or oil) and push it into the inlet 802.

The end plate 900, finally, is shown in a plan view to illustrate the surface of the end plate 900 that faces outward from the rotor laminations (not shown) when installed. An opposite surface of the end plate 900 (not shown) instead faces inward toward the rotor laminations when installed. The end plate 900 has a central opening 902 (e.g., of circular shape) that can accommodate a rotor shaft (not shown) and/or another component. The end plate 900 includes holes 904 for installation of rivets that may extend through the rotor stack from end to end for compressing the rotor. For example, the holes 904 can be chamfered at the outside face of the end plate 900.

The end plate 900 can form one or more inlets 906 for a centrifugal pump. The inlet(s) 906 allow the centrifugal pump to draw fluid and flow the fluid through at least one channel in the rotor body. The end plate 900 can have a surface for abutting the end of the rotor body (e.g., the outermost of multiple rotor laminations). The inlet 906, moreover, can be formed by one or more features defined in relation to such a surface. In some implementations, the inlet 906 includes a recessed area 908 (hidden from view). The recessed area 908 can be a portion where the end plate 900 has a smaller thickness than at the lamination-abutting surface. As such, the recessed area 908 of the end plate 900 does not abut the end of the rotor body when installed. The inlet 906 includes a hole 910 extending through a thickness of the end plate 900. The hole 910 can have any shape, including, but not limited to, a deformed rectangle (e.g., as shown). Other shapes can be used for the hole 910. The recessed area 908 can have any shape. In some implementations, the recessed area 908 can be substantially symmetric about a radius of the end plate 900 (e.g., as shown). For example, the recessed area 908 can be symmetric about the hole 910. In some implementations, the recessed area 908 can have substantially a wedge shape (e.g., as shown).

The inlet 906 includes an outside peripheral lip 912 that closes the recessed area 908. The outside peripheral lip 912 can extend substantially around the entire periphery of the end plate 900, except as noted in examples described below. At the outside peripheral lip 912, the end plate 900 may have substantially the same thickness as at the lamination-abutting surface. For example, when the end plate 900 is installed, the outside peripheral lip 912 can abut the end of the rotor body. The inlet 906 can include one or more ribs. For example, the rib can divide the recessed area 908 to guide the fluid at the inlet 906.

The end plate 900 can form one or more outlets 914 for the centrifugal pump. The outlet(s) 914 allow the centrifugal pump to expel fluid that has flowed through at least one channel in the rotor body. That is, the outlet(s) 914 of the end plate 900 can expel fluid that originally entered the rotor through another inlet at the opposite end of the rotor, not through any of the inlets 906 of the end plate 900. The outlet(s) 914 can be formed by one or more features defined in relation to the lamination-abutting surface. In some implementations, the outlet(s) 914 includes a recessed area 916 (hidden from view). The recessed area 916 can be a portion where the end plate 900 has a smaller thickness than at the lamination-abutting surface. As such, the recessed area 916 of the end plate 900 does not abut the end of the rotor body when installed. The recessed area 916 can have any shape. In some implementations, the recessed area 916 can have a wedge shape (e.g., as shown).

The outlet(s) 914 includes a recess 918 in the outside peripheral lip 912. At the recess 918, the end plate 900 may have a smaller thickness than at the lamination-abutting surface. For example, at the recess 918 the end plate 900 may have substantially the same thickness as does the recessed area 916. The recess 918 allows fluid in the recessed area 916 to be expelled away from the end plate 900.

The inlet 906 and the outlet 914 positioned adjacent each other can form a pair 920. The end plate 900 can include multiple instances of the pair 920 distributed about a periphery of the end plate 900. For example, here the end plate 900 includes six instances of the pair 920 that are equally distributed.

When being installed on the rotor, the end plate 900 can be non-clocked with a corresponding (e.g., identical) end plate mounted to the opposite rotor end. That is, in all possible angular orientations in which the end plate 900 can be installed (i.e., so that the holes 904 line up for rivet installation), each of the inlets 906 of the end plate 900 lines up with a corresponding outlet of the other end plate at the opposite end, and vice versa. Each of these angular orientations will allow the centrifugal pump to draw fluid through one of the inlets 906, flow the fluid through a channel, and expel the fluid through the outlet at the opposite end plate. Likewise, each of the angular orientations will allow the centrifugal pump to draw fluid through one of the inlets at the opposite end plate, flow the fluid through another channel, and expel the fluid through one of the outlets 914. As such, the end plate 900 and an identical end plate at the opposite end of the rotor body are non-clocked with each other.

FIG. 10 schematically shows a section of end plates 1000 and 1002 and air channels 1004 and 1006 in a rotor stack to illustrate a flow of fluid by way of a centrifugal pump. This 60-degree section shows a view of the fluid volume formed by passages in the rotor stack and the end plates 1000-1002. The channels 1004 and 1006 are mentioned here as examples. All connections between the end plates 1000 and 1002 can serve as fluid channels. The present 60-degree section includes eight fluid channels, and the full rotor includes 48 fluid channels. For example, with reference to FIG. 2, all the holes 204A-1, 204A-2, 204B-1, 204B-2, 206A-1, 206A-2, 206B-1, and 206B-2 can serve as fluid channels also in the present example. The illustrated example can be used with one or more other examples described elsewhere herein. Each of the end plates 1000-1002 here corresponds to the end plate 900 in FIG. 9. For example, the end plates 1000 and 1002 correspond to the case where both inlet and outlet are in a 60-degree section (not a 120-degree section), and where clocking of the end plates 1000 and 1002 during assembly is not required. A hole 1008 in the end plate 1000 can correspond to any of the holes 204A-204B or 206A-206B in FIG. 2.

The rotor has an inlet 1010 leading to the channel 1004 and thereafter to an outlet 1012. Similarly, the rotor has the hole 1008 leading to the channel 1006 and thereafter to an outlet 1014. The inlet 1010 and the outlet 1014 are here formed in the end plate 1002. Similarly, the outlet 1012 and the hole 1008 are here formed in the end plate 1000. The rotor allows fluid to flow through channels (including, but not limited to, the channels 1004 and 1006) (e.g., in opposing directions to each other) for thermal control of the rotor.

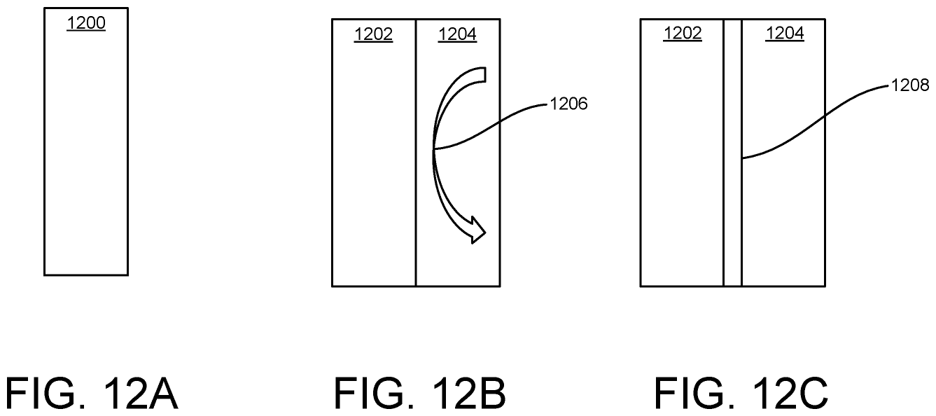

FIGS. 11A-11D show examples of various locations within a rotor stack being used as channels for fluid flow. FIGS. 12A-12C show radial views relating to the rotor laminations in FIGS. 11A-11D. Any or all features can be used with one or more other examples described elsewhere herein. In each of FIGS. 11A-11D, a portion of a rotor stack is being shown in an axial direction. While the stack contains multiple rotor lamination, only a nearest outermost rotor lamination is visible in each view. Other rotor laminations of the respective stacks will be mentioned in the examples, and some of their features may be made visible for illustrative purposes. Each visible rotor lamination is only partially shown for simplicity, and may have a pattern that repeats itself in a rotational direction about the rotor axis.

A rotor lamination 1100 (FIG. 11A) includes a magnet 1102A positioned in an opening having holes 1102A-1 and 1102A-2, respectively. The rotor lamination 1100 also includes a magnet 1102B positioned in an opening having holes 1102B-1 and 1102B-2, respectively. One or more of the holes 1102A-1, 1102A-2, 1102B-1, or 1102B-2 can serve as a channel for a centrifugal pump to flow fluid through at least part of the rotor stack. The rotor stack having the rotor lamination 1100 has no skew in the positions of the magnets along the length of the rotor axis. The rotor laminations therefore can be said to form a single stack 1200, as illustrated in a radial view by FIG. 12A. That is, the single stack 1200 is a stack of rotor laminates where none of the laminates are offset by rotation.

An example that involves a skewed rotor will now be described. A rotor lamination 1104 (FIG. 11B) includes a magnet 1106A positioned in an opening having holes 1106A-1 and 1106A-2, respectively. The rotor lamination 1104 also includes a magnet 1106B positioned in an opening having holes 1106B-1 and 1106B-2, respectively. This illustration also shows features from one of the other rotor laminations in the same rotor stack as the rotor lamination 1104. That other rotor lamination, which is not shown here and could be positioned behind or in front of the rotor lamination 1104 in the present perspective, includes a magnet 1108A positioned in an opening having holes 1108A-1 and 1108A-2, respectively, and a magnet 1108B positioned in an opening having holes 1108B-1 and 1108B-2, respectively. The magnets 1106A and 1108A, which are located at different axial depth along the rotor shaft, are here skewed relative to each other. Similarly, the magnets 1106B and 1108B, which are also located at different axial depth along the rotor shaft, are here skewed relative to each other. The skew is created because the rotor laminations form two stacks 1202 and 1204, as illustrated in a radial view by FIG. 12B. An arrow 1206 at the stack 1204 here schematically illustrates that the magnets in the stack 1204 are offset by rotation relative to the stack 1202.

The skew in the magnet positions means that the corresponding holes formed adjacent the skewed magnets do not necessarily line up from end to end of the rotor. One or more interconnects can therefore be used to provide a continuous path for fluid flow. FIG. 11C shows the rotor lamination 1104 and also indicates an interconnect 1110 that connects the holes 1106A-1 and 1108A-1 to each other. Similarly, an interconnect 1112 connects the holes 1106A-2 and 1108A-2 to each other; an interconnect 1114 connects the holes 1106B-1 and 1108B-1 to each other; and an interconnect 1116 connects the holes 1106B-2 and 1108B-2 to each other. Any or all of the interconnects 1110-1116 can be formed as an opening in a rotor lamination (including, but not limited to, the hole 212 in FIG. 2). For example, the hole 212 can be positioned so as to at least partially overlap, in directions perpendicular to the rotor axis, both holes in any of the pairs of holes mentioned above. FIG. 11D shows the interconnects 1110-1116, which may be formed in a common rotor lamination, here rotor lamination 1118, or may be distributed among two or more rotor laminations. FIG. 12C schematically illustrates, in the radial view, that an interconnect 1208 is positioned between the stacks 1202 and 1204 and can serve as a middle (or intermediate) section that connects the skewed stack holes. The interconnect 1208 can at least partially overlap respective holes in the stacks 1202 and 1204 so that a channel continues through the length of the skewed rotor.

As the previous example indicates, an interconnect can be any of multiple possible structures. In some implementations, the interconnect 1208 is a separate plate of the rotor stack, which plate does not have any magnets. For example, the interconnect 1208 can then act solely as a fluid interconnect. In some implementations, the interconnect 1208 is a separate lamination stack within the rotor, the stack having magnets and also the flow path(s). In some implementations, one or more of the interconnects 1110-1116 is part of the stacks 1202 and 1204 only in the mating region. In some implementations, one or more of the interconnects 1110-1116 is part of the stacks 1202 and 1204 throughout the entire rotor stack.

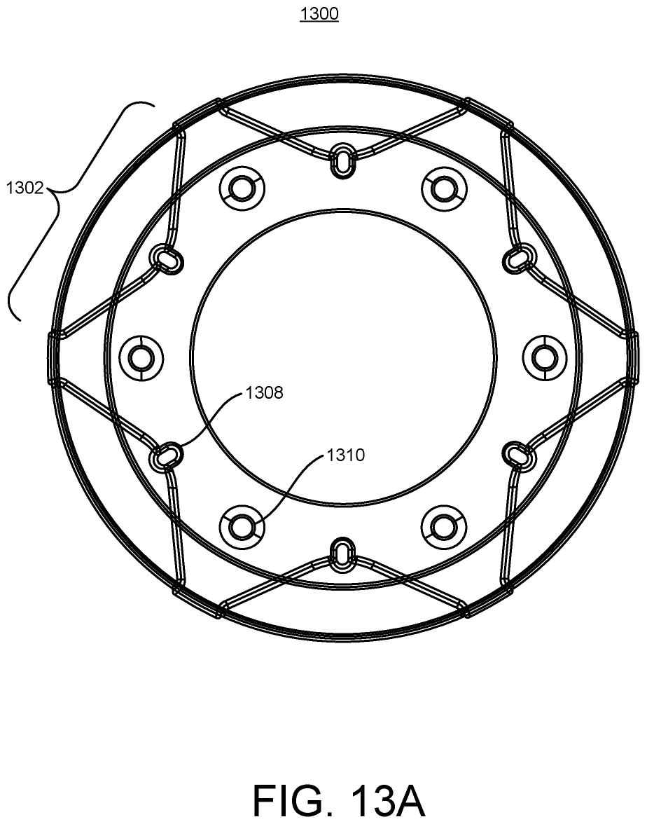

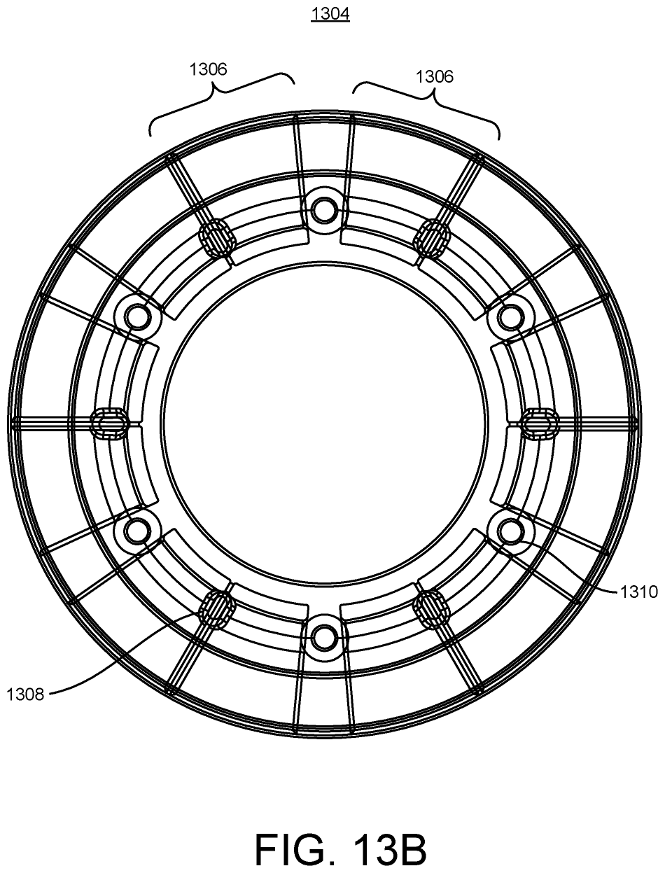

FIGS. 13A-13B show examples relating to an end plate 1300 with outlet channels 1302, and an end plate 1304 with inlet channels 1306, respectively. The end plate 1300 has six instances of the outlet channels 1302 arranged around its periphery. Each of the outlet channels 1302 can be created by way of forming a recess from the surface of the outermost rotor lamination, which allows a fluid to travel through channels in the rotor. In the end plate that is at the opposite end of the rotor, such as the end plate 1304, the fluid can exit through outlets at the outer diameter.

The end plate 1304 has six instances of pairs of the inlet channels 1306 arranged around its periphery. Each of the inlet channels 1306 can be created by way of forming a recess from the surface of the outermost rotor lamination, which allows a fluid to travel through channels in the rotor.

In a design that uses the end plates 1300 and 1304, a fluid can enter the rotor from the inlet channels 1306 at one side of the rotor. The fluid can flow through the holes in laminations (e.g., adjacent magnets therein) along the rotor's length from one end of the rotor to the other. The fluid can exit the rotor from the outer diameter of the outlet channels 1302 at the other end of the rotor. Such a loop of fluid flow can be closed by fluid flowing through the airgap between the rotor and stator. As such, this example of a plate design provides a one-way flow of fluid along the rotor stack.

Either or both of the end plates 1300 or 1304 can have one or more scheduler 1308. For example, the scheduler 1308 can ensure that the end plate and the stack of rotor laminations are properly oriented relative to each other. Either or both of the end plates 1300 or 1304 can have one or more hole 1310 for a retaining pin. As another example, the hole 1310 can be used in retaining the laminations and compressing them together.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. An electric motor comprising:
a stator; and
a rotor comprising:
a rotor body; and
a centrifugal pump to flow a fluid in a channel extending axially through the rotor body from end to end.

2. The electric motor of claim 1, wherein the channel extends through a magnet hole in the rotor body.

3. The electric motor of claim 2, wherein the channel is formed adjacent a magnet positioned in the magnet hole.

4. The electric motor of claim 3, wherein the channel is formed between at least two magnets positioned in the magnet hole.

5. The electric motor of claim 1, wherein the channel is formed in a hole of the rotor body that does not contain a magnet.

6. The electric motor of claim 1, wherein the rotor body is formed by laminates, and wherein the laminates contain respective holes that form the channel.

7. The electric motor of claim 6, wherein the electric motor includes first and second end plates forming the centrifugal pump, and wherein the first and second end plates are clocked with each other.

8. The electric motor of claim 6, wherein the electric motor includes first and second end plates forming the centrifugal pump, and wherein the first and second end plates are non-clocked with each other.

9. The electric motor of claim 6, wherein the electric motor includes first and second end plates forming the centrifugal pump, wherein the channel comprises first and second channels formed by the laminates, and wherein a first flow through the first channel occurs in an opposite direction to a second flow through the second channel.

10. The electric motor of claim 6, wherein the electric motor includes first and second end plates forming the centrifugal pump, wherein the channel comprises first and second channels formed by the laminates, and wherein a first flow through the first channel occurs in a same direction as a second flow through the second channel.

11. The electric motor of claim 6, wherein the channel comprises first and second channels formed by the laminates.

12. The electric motor of claim 11, wherein the electric motor includes an end plate forming the centrifugal pump, wherein the centrifugal pump comprises an inlet formed in the end plate, the inlet aligned with the first channel, and an outlet formed in the end plate, the outlet aligned with the second channel, wherein the centrifugal pump flows first fluid into the first channel and flows second fluid out of the second channel.

13. The electric motor of claim 12, wherein the inlet comprises a hole through the end plate, a recessed area in the end plate that does not abut the laminates, the recessed area covering the first channel, and an outside peripheral lip that closes the recessed area.

14. The electric motor of claim 13, further comprising a rib that divides the recessed area to guide the fluid at the inlet.

15. The electric motor of claim 13, wherein the recessed area has substantially an arcuate shape.

16. The electric motor of claim 13, wherein the recessed area has substantially a wedge shape.

17. The electric motor of claim 13, wherein the inlet further comprises a scoop forming the hole.

18. The electric motor of claim 12, wherein the outlet comprises a recessed area in the end plate that does not abut the laminates, the recessed area covering the second channel, and a recess in an outside peripheral lip of the end plate.

19. The electric motor of claim 18, wherein the recessed area is symmetric about a radius of the rotor body.

20. The electric motor of claim 12, wherein the end plate comprises multiple pairs each including a respective inlet and a respective outlet, the multiple pairs distributed about a periphery of the end plate.

21. The electric motor of claim 12, wherein the end plate further comprises a site with material removed for rotor balancing.

22. The electric motor of claim 1, wherein an inlet for the channel is formed in a shaft of the rotor.

23. The electric motor of claim 1, wherein the fluid comprises at least one of air or oil.
